(19) United States
(12) Patent Application Publication
(10) Pub. No.: US 2026/0128345 A1
(43) Pub. Date: May 7, 2026

(54) Battery Cell Manufacturing Apparatus and a Control Method Thereof

(71) Applicant: SK On Co., Ltd., Seoul (KR)

(72) Inventor: Jae Sung BAE, Daejeon (KR)

(21) Appl. No.: 19/369,958

(22) Filed: Oct. 27, 2025

(30) Foreign Application Priority Data
Oct. 29, 2024 (KR) 10-2024-0149451

(51) Int. Cl. H01M 10/04

(52) U.S. Cl. CPC H01M 10/0404

(57) ABSTRACT

The present disclosure relates to a battery cell manufacturing apparatus for manufacturing a battery cell comprising: a case accommodating an electrode assembly; an injection hole penetrating one surface of the case; and a sealing member coupled to the case to cover the injection hole, the battery cell manufacturing apparatus comprising: an insertion unit configured to insert the sealing member into the injection hole; and a fusion unit configured to contact the sealing member inserted into the injection hole and fusion-bond the sealing member to the case; and a control method thereof.

### CROSS-REFERENCE TO RELATED PATENT APPLICATION

The present application claims priority under 35 U.S.C. § 119(a) to Korean patent application number 10-2024-0149451 filed on October 29, 2024, in the Korean Intellectual Property Office, the entire disclosure of which is incorporated by reference herein.

### BACKGROUND OF THE INVENTION

### 1. Field

Embodiments of the present disclosure relate to a battery cell manufacturing apparatus and a control method thereof. More specifically, the present disclosure relates to a battery cell manufacturing apparatus and a control method thereof in which the sealing force of a sealing member sealing an injection hole of a battery cell is improved.

### 2. Description of the Related Art

A battery cell (or secondary battery) requires a process of injecting an electrolyte into the inside of a case. For this purpose, a typical battery cell includes an injection hole for electrolyte injection. The typical battery cell undergoes a process of injecting the electrolyte through the injection hole, performing degassing, and then inserting a pin or a ball into the injection hole to block moisture. In this case, the pin or the ball is press-fitted into the injection hole to close the injection hole.

However, the pin or the ball may be damaged due to various causes, which makes it easy for leakage to occur. In addition, since the pin or the ball is relatively small in size and present in a large quantity, it may be difficult for an operator or an inspection device to inspect defects of the pin or the ball.

### SUMMARY OF THE INVENTION

First, according to one aspect of the present disclosure, the problem to be solved is to improve the manufacturing process of a battery cell and thereby enhance productivity of the battery cell.

Second, according to another aspect of the present disclosure, the problem to be solved is to supplement the process of inserting a ball or a pin into an injection hole of the battery cell.

Third, according to another aspect of the present disclosure, the problem to be solved is to improve the sealing force of the battery cell and thereby prevent leakage of the electrolyte.

Fourth, according to still another aspect of the present disclosure, the problem to be solved is to improve the lifespan of the battery cell.

Meanwhile, the battery cell manufactured by the battery cell manufacturing apparatus according to the present disclosure can be widely applied to fields of green technology such as electric vehicles (EVs), battery charging stations, and energy storage systems (ESS), as well as photovoltaics and wind power utilizing batteries. In addition, the battery cell according to the present disclosure can be used in eco-friendly mobility, including electric vehicles and hybrid vehicles, to suppress air pollution and greenhouse gas emissions and thereby prevent climate change.

As a technical means to achieve the technical objects, a battery cell manufacturing apparatus for manufacturing a battery cell comprising a case accommodating an electrode assembly, an injection hole penetrating one surface of the case, and a sealing member coupled to the case to cover the injection hole, the battery cell manufacturing apparatus according to the present disclosure may comprise a fusion unit including a heater portion configured to contact the sealing member inserted into the injection hole and heat the sealing member.

In addition, the heater portion may be a heater in a film shape.

In addition, the fusion unit may further include a fusion housing including a receiving opening opened at one surface and configured to surround the sealing member through the receiving opening, and a fusion pipe having a pipe shape, inserted through the fusion housing, and configured to move the heater portion positioned at a lower side into contact with the sealing member.

In addition, the fusion unit may further include a decompression portion configured to discharge gas from the inside of the case through the fusion pipe at a pressure lower than an internal pressure of the case.

In addition, the heater portion may heat the sealing member for a predetermined elapsed time such that at least a portion of the sealing member is deformed to form a fusion portion between the sealing member and the case.

In addition, the battery cell manufacturing apparatus according to the present disclosure may further include a fixing jig configured to fix a position of the battery cell.

In addition, the battery cell manufacturing apparatus according to the present disclosure may further include an insertion unit configured to insert the sealing member into the injection hole.

In addition, the insertion unit may include: a supply portion configured to supply the sealing member; a guide portion configured to guide the sealing member supplied through the supply portion to the injection hole; and a pressing portion configured to press the sealing member guided to the injection hole by the guide portion to insert the sealing member into the injection hole.

In addition, the pressing portion may insert the sealing member into the injection hole in a press-fit manner.

As a technical means to achieve the technical objects, a control method of a battery cell manufacturing apparatus including an insertion unit and a fusion unit, the insertion unit being configured to insert a sealing member, and the fusion unit including a heater portion configured to contact and heat the sealing member, for manufacturing a battery cell comprising a case accommodating an electrode assembly, an injection hole penetrating one surface of the case, and the sealing member coupled to the case to cover the injection hole, the control method of the battery cell manufacturing apparatus according to the present disclosure may include: inserting the sealing member into the injection hole through the insertion unit; and fusion-bonding the sealing member inserted into the injection hole to couple the sealing member to the case through the fusion unit.

In addition, the inserting of the sealing member may be performed by inserting the sealing member into the injection hole through a pressing portion of the insertion unit, the insertion unit including a supply portion configured to supply the sealing member, a guide portion configured to guide the supplied sealing member to the injection hole, and the pressing portion configured to press the sealing member guided to the injection hole by the guide portion.

In addition, the inserting of the sealing member may be performed by inserting the sealing member in a press-fit manner through the pressing portion.

In addition, the coupling of the sealing member to the case by fusion may include a fusion step of heating the sealing member through the heater portion in contact with the sealing member, in the fusion unit further comprising a fusion housing including a receiving opening opened at one surface, and a fusion pipe having a pipe shape, inserted through the fusion housing and movable such that the heater portion positioned at a lower side contacts the sealing member, thereby fusion-bonding the sealing member to the case.

In addition, the coupling of the sealing member to the case by fusion may further include, prior to the fusion step, a moving step of bringing the fusion housing into contact with the one surface of the case while the fusion housing surrounds the sealing member through the receiving opening; and a decompression step of moving the fusion pipe to contact the sealing member and discharging air inside the case through the fusion pipe.

In addition, the control method of the battery cell manufacturing apparatus according to the present disclosure may further include, after the coupling of the sealing member to the case by fusion, assembling a sealing cover to the case such that the sealing cover surrounds the sealing member fusion-bonded to the case.

First, according to one embodiment of the present disclosure, the manufacturing process of a battery cell can be improved to enhance productivity of the battery cell.

Second, according to another embodiment of the present disclosure, the process of inserting a ball or a pin into an injection hole of the battery cell can be supplemented.

Third, according to another embodiment of the present disclosure, the sealing force of the battery cell can be improved to prevent leakage of the electrolyte.

Fourth, according to still another embodiment of the present disclosure, the lifespan of the battery cell can be improved.

### BRIEF DESCRIPTION OF THE DRAWINGS

FIG. 1 is an example of a battery cell manufactured by a battery cell manufacturing apparatus according to the present disclosure.

FIG. 2 is an exploded view of an example of a battery cell manufactured by a battery cell manufacturing apparatus according to the present disclosure.

FIG. 3 is another example of a battery cell manufactured by a battery cell manufacturing apparatus according to the present disclosure.

FIG. 4 is an enlarged view of an injection portion.

FIGS. 5A to 5C illustrate a method of coupling a sealing member and a sealing cover when the sealing member has a pin shape.

FIGS. 6A to 6C illustrate a method of coupling a sealing member and a sealing cover when the sealing member has a ball shape.

FIG. 7 illustrates a method of placing the sealing member into the injection hole through an insertion unit.

FIG. 8 illustrates a method of inserting the sealing member into the injection hole through a pressing portion.

FIG. 9 illustrates an example of surrounding the sealing member through a fusion unit.

FIG. 10 illustrates an example of coupling the sealing member to the case by heating the sealing member through a heater portion.

FIG. 11 illustrates a control block diagram of the battery cell manufacturing apparatus according to the present disclosure.

FIG. 12 illustrates an example of a control method of the battery cell manufacturing apparatus according to the present disclosure in a flow chart.

### DETAILED DESCRIPTION

Hereinafter, preferred embodiments according to the present disclosure will be described in detail with reference to the accompanying drawings. The configuration of the apparatus or the control method described below is merely for illustrating embodiments according to the present disclosure, and is not intended to limit the scope of rights according to the present disclosure. Reference numerals used consistently throughout the specification denote the same elements.

Specific terms used in the present specification are merely for convenience of explanation and are not used as limitations of the illustrated embodiments.

For example, expressions such as “same” and “identical” not only indicate a strictly identical state, but also indicate a state in which tolerances exist, or in which differences to such an extent that the same function can be obtained are present.

For example, expressions indicating relative or absolute arrangements, such as “in a certain direction,” “along a certain direction,” “parallel,” “perpendicular,” “toward the center,” “concentric,” or “coaxial,” not only indicate such arrangements strictly, but also indicate states in which tolerances exist, or in which relative displacement occurs with an angle or distance to such an extent that the same function can be obtained.

In order to describe the present disclosure, the following description is made based on a spatial orthogonal coordinate system defined by mutually orthogonal X-axis, Y-axis, and Z-axis. Unless otherwise specified, the Z-direction refers to a height direction, the X-direction (or first direction) refers to one of directions perpendicular to the height direction, and the Y-direction (or second direction) refers to a direction perpendicular to the Z-direction and the X-direction.

However, the X-direction, Y-direction, and Z-direction referred to below are provided for the purpose of facilitating clear understanding of the present disclosure, and it goes without saying that each direction may be defined differently depending on where the reference is set.

The use of terms such as “first,” “second,” and “third” before components mentioned hereinafter is merely for avoiding confusion among the referred components, and is not related to order, importance, or superiority/subordination among the components. For example, an invention including only a second component without a first component may also be implemented.

Singular expressions used in the present specification include plural expressions unless the context clearly indicates otherwise.

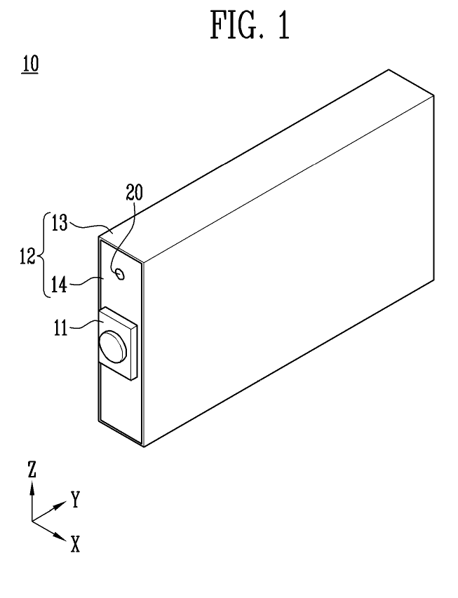

FIG. 1 is an example of a battery cell manufactured by a battery cell manufacturing apparatus according to the present disclosure.

The battery cell 10 according to the present disclosure refers to a secondary battery capable of being repeatedly used by charging and discharging electrical energy. As one example, it may be a lithium secondary battery, but is not limited thereto.

The battery cell 10 according to the present disclosure may be classified, according to its shape, into a pouch-type secondary battery, a prismatic secondary battery, or a cylindrical secondary battery. Referring to FIG. 1, for convenience of explanation, a prismatic secondary battery is illustrated as one example in the present specification, but the present disclosure is not limited thereto. That is, as long as welding for sealing can be replaced, the present disclosure may be applied regardless of the form of the battery cell 10.

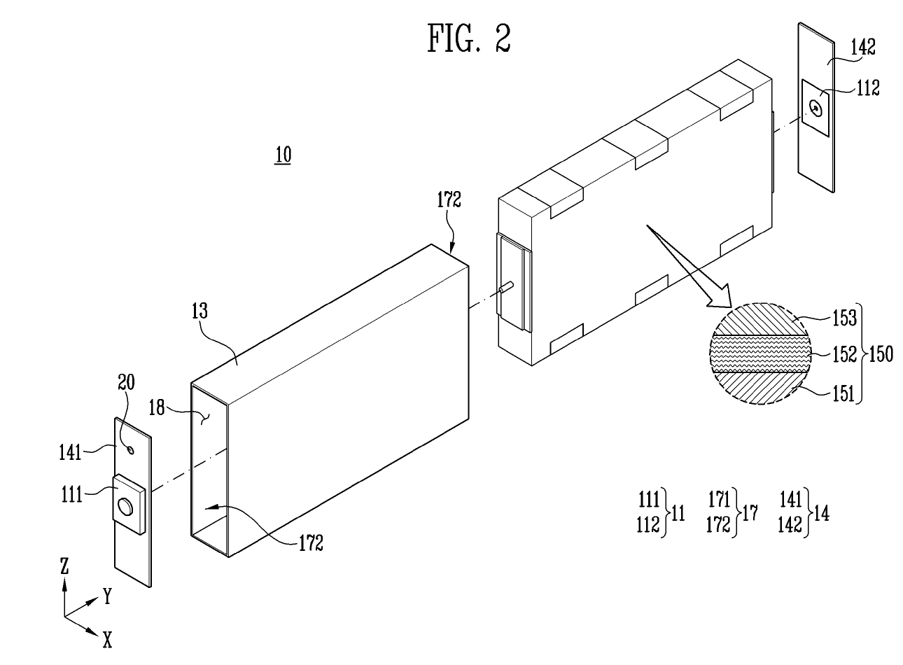

Referring to FIG. 1, a battery cell 10 manufactured by a battery cell manufacturing apparatus 1000 according to the present disclosure may include an electrode assembly 150 (see FIG. 2) comprising a positive electrode, a negative electrode, and a separator, and a case 12 accommodating the electrode assembly 150 therein.

The case 12 may include a body case 13 including an inlet 17 (see FIG. 2) opened at one surface, and a cover portion 14 (or a cap assembly) coupled to the body case 13 to cover the inlet 17.

The case 12 may accommodate the electrode assembly 150 therein. The case 12 may accommodate the electrode assembly and an electrolyte therein. The case 12 may be formed of a metal material. For example, the case 12 may include an aluminum layer. That is, the case 12 may include a material having high mechanical rigidity to protect the battery cell 10 from external impact.

The cover portion 14 may include a terminal portion 11 for electrically connecting the electrode assembly 150 to the outside.

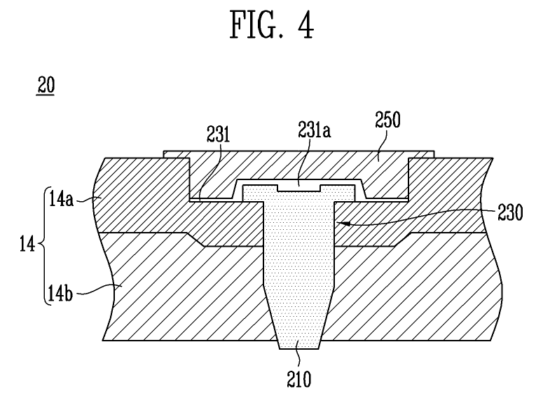

Meanwhile, the battery cell 10 may include an injection portion 20 comprising an injection hole 230 (see FIG. 4) penetrating the case 12 to inject an electrolyte into the inside of the case 12 during a manufacturing process of the battery cell, and a sealing member 210 (see FIG. 4) configured to close the injection hole 230.

As one example, the injection portion 20 may be located at the cover portion 14.

Meanwhile, the injection hole 230 may also be used to remove gas (or air) generated during a charge/discharge process after injecting the electrolyte through the injection hole 230.

FIG. 2 is an exploded view of an example of a battery cell manufactured by a battery cell manufacturing apparatus according to the present disclosure.

Referring to FIG. 2, a battery cell 10 manufactured by a battery cell manufacturing apparatus 1000 according to the present disclosure may include an electrode assembly 150, a case 12 accommodating the electrode assembly 150, an injection hole 230 penetrating one surface of the case 12, and a sealing member 210 coupled to the case 12 to cover the injection hole 230.

Specifically, the battery cell 10 manufactured by the battery cell manufacturing apparatus 1000 according to the present disclosure may include: the electrode assembly 150; a body case 13 including an inlet 17 at one surface and accommodating the electrode assembly 150 therein through the inlet 17; and a cover portion 14 coupled to the body case 13 to cover the inlet 17.

The electrode assembly 150 may include a positive electrode 151, a negative electrode 153, and a separator 152 configured to separate the positive electrode 151 and the negative electrode 153 from each other. The electrode assembly 150 may be classified into a stacking type, a winding type, a stack-folding type, or a Z-stacking type according to a manner in which the positive electrode 151, the negative electrode 153, and the separator 152 are stacked. The type of the electrode assembly 150 included in the battery cell 10 according to the present disclosure is not limited. That is, the battery cell 10 according to the present disclosure may include the electrode assembly 150 manufactured in any one of the stacking type, winding type, stack-folding type, or Z-stacking type.

The battery cell 10 may include a positive electrode current collector (not shown) connected to the stacked positive electrodes 151 to allow current to flow, and a negative electrode current collector (not shown) connected to the stacked negative electrodes 153 to allow current to flow. The positive electrode current collector and the negative electrode current collector may include a known conductive material within a range in which no chemical reaction occurs in a lithium secondary battery. For example, the current collector may include any one of stainless steel, nickel (Ni), aluminum (Al), titanium (Ti), copper (Cu), and alloys thereof, and may be provided in various forms such as a film, a sheet, or a foil.

The positive electrode current collector and the negative electrode current collector may electrically connect the electrode assembly 150 to the outside through the terminal portion 11.

Meanwhile, the positive electrode 151 and the negative electrode 153 may include an active material. The positive electrode 151 may include a positive electrode active material, and the negative electrode 153 may include a negative electrode active material. The positive electrode active material may be a material into which lithium ions can be inserted and from which lithium ions can be extracted, and the negative electrode active material may be a material onto which lithium ions can be adsorbed and from which lithium ions can be desorbed.

For example, the positive electrode active material may be a lithium metal oxide, and the negative electrode active material may be any one of carbon-based materials such as crystalline carbon, amorphous carbon, carbon composites, and carbon fibers, lithium alloys, silicon (Si), or tin (Sn).

In addition, the positive electrode 151 and the negative electrode 153 may further include a binder (not shown) and a conductive material (not shown) to improve mechanical stability and electrical conductivity.

The separator 152 may be configured to prevent an electrical short circuit between the positive electrode 151 and the negative electrode 153 and to allow the flow of ions. The type of the separator is not particularly limited, but may include a porous polymer film (membrane or thin film). For example, the separator 152 may include a porous polymer film or a porous nonwoven fabric.

Meanwhile, the battery cell 10 may include an electrolyte (not shown) for immersing the electrode assembly 150 positioned inside the case 12. The electrolyte may be a non-aqueous electrolyte. The electrolyte may include a lithium salt and an organic solvent. The electrolyte may further include an additive. The additive may form a film on the positive electrode or the negative electrode through a chemical reaction inside the battery. For example, the positive electrode 151 may form a cathode interface film, and the negative electrode 153 may form an anode interface film.

Referring to FIG. 2, the body case 13 may include an inlet 17 at one surface and accommodate the electrode assembly 150 therein through the inlet 17. That is, the body case 13 may form a receiving space 18 for accommodating the electrode assembly 150 therein.

The cover portion 14 may include a terminal portion 11 (see FIG. 1) electrically connecting the electrode assembly 150 to the outside. Through this, the electrode assembly 150 may be electrically connected to the outside.

In addition, as described above, the case 12 may include an injection portion 20 located at one surface of the case. Preferably, the injection portion 20 may be located at the cover portion 14. When manufacturing the battery cell 10, the battery cell manufacturing apparatus 1000 according to the present disclosure may inject the electrolyte through the injection portion 20 and perform degassing to discharge gas (or air) filled inside the case 12 to the outside.

The injection portion 20 may include an injection hole 230 penetrating one surface of the case 12, and a sealing member 210 (see FIG. 4) inserted into the injection hole 230 and fusion-bonded to the one surface of the case 12 to close the injection hole 230.

Meanwhile, referring to FIG. 2, the battery cell 10 may include: the electrode assembly 150; the body case 13 accommodating the electrode assembly; a first inlet 171 formed on one surface of the body case 13; a second inlet 172 formed on the other surface of the body case 13 facing the one surface of the body case 13; a first cover portion 141 coupled to the body case 13 to cover the first inlet 171; and a second cover portion 142 coupled to the body case 13 to cover the second inlet 172.

The terminal portion 11 may include a first terminal portion 111 disposed on the first cover portion 141 and a second terminal portion 112 disposed on the second cover portion 142. Preferably, the polarity of the first terminal portion 111 and the second terminal portion 112 may be opposite to each other.

Meanwhile, the injection portion 20 may be located on at least one of the first cover portion 141 and the second cover portion 142. For injecting the electrolyte and performing degassing, it is sufficient that the injection portion 20 is located on only one of the first cover portion 141 and the second cover portion 142. FIG. 2 illustrates an example in which the injection portion 20 is located on the first cover portion 141.

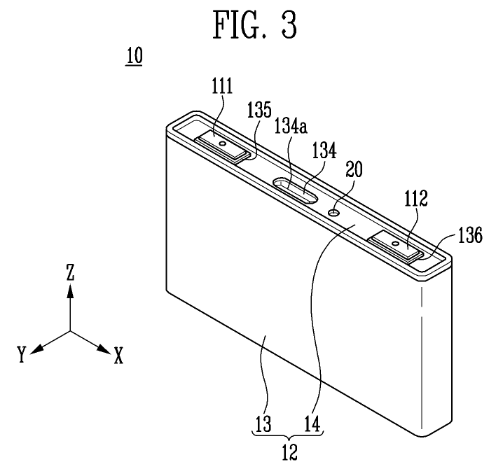

FIG. 3 is another example of a battery cell manufactured by a battery cell manufacturing apparatus according to the present disclosure.

Unlike the battery cell 10 described in FIGS. 1 and 2, the battery cell 10 illustrated in FIG. 3 may have both the first terminal portion 111 and the second terminal portion 112 located on one surface of the case 12. Referring to FIG. 3, the battery cell 10 manufactured by the battery cell manufacturing apparatus 1000 according to the present disclosure may include: a case 12 accommodating an electrode assembly 150 (see FIG. 2); an injection portion 20 including an injection hole 230 (see FIG. 4) penetrating the case 12 to inject an electrolyte into the inside of the case 12; and a sealing member 210 (see FIG. 4) configured to close the injection hole 230.

More specifically, the case 12 may include: a body case 13 including an opening on one surface and accommodating the electrode assembly 150 through the opening; and a cover portion 14 coupled to the body case 13 to cover the opening.

The cover portion 14 may include a first terminal portion 111 and a second terminal portion 112 having different electrical polarities.

Referring to FIG. 3, the first terminal portion 111 and the second terminal portion 112 may be disposed spaced apart from each other along the X-direction. In addition, the cover portion 14 may further include a first gasket 135 and a second gasket 136 configured to insulate and seal the first terminal portion 111 and the second terminal portion 112, respectively.

The first gasket 135 and the second gasket 136 may surround at least a portion of the first terminal portion 111 and the second terminal portion 112. The first gasket 135 and the second gasket 136 may electrically insulate the first terminal portion 111 and the second terminal portion 112, respectively, and prevent the electrolyte from leaking through the first terminal portion 111 and the second terminal portion 112.

The injection portion 20 may be located on one surface of the case 12. As one example, the injection portion 20 may be located on the cover portion 14 forming one surface of the case 12.

Referring to FIG. 3, the cover portion 14 may include a venting hole 134. The venting hole 134 may be sealed with a vent plate 134a so that gas (or air) filled inside the case 12 can be discharged when an internal pressure of the case 12 reaches a predetermined allowable pressure. That is, when the internal pressure of the case 12 reaches the allowable pressure, the vent plate 134a may be cut and the venting hole 134 may be opened.

FIG. 4 is an enlarged view of an injection portion.

More specifically, FIG. 4 is an enlarged cross-sectional view of one end of the injection portion 20 located on one surface of the case 12 or on the cover portion 14 forming one surface of the case 12.

The injection portion 20 may include an injection hole 230 penetrating one surface of the case 12, and a sealing member 210 inserted into the injection hole 230 and fusion-bonded to the one surface of the case 12 to close the injection hole 230.

In addition, the injection portion 20 may further include a sealing cover 250 located above the sealing member 210 to cover the sealing member 210. That is, FIG. 2 illustrates an example of the battery cell 10 sealed by the sealing member 210 and the sealing cover 250 in order to prevent leakage of the electrolyte through the injection hole 230.

Referring to FIG. 4, the cover portion 14 may include an outer cover 14a exposed to the outside, and an insulating plate 14b located below the outer cover 14a.

The injection hole 230 may be formed by penetrating through each of the outer cover 14a and the insulating plate 14b. In the present specification, the injection hole 230 is illustrated in a simplified manner as penetrating one surface of the body case 13 or the cover portion 14.

Referring to FIG. 4, one surface of the case 12 or the cover portion 14 may have a stepped inner surface 233 of the injection hole, thereby forming a recessed space 231a into which at least a portion of the sealing cover 250 is inserted. In addition, due to the recessed space 231a, it is possible to prevent the sealing member 210 from protruding to an outer surface of the case 12 or an outer surface of the cover portion 14.

Meanwhile, the sealing member 210 is typically provided in a ball shape or a pin shape, and the sealing member 210 may be press-fitted into the injection hole 230 and coupled to the case 12 or the cover portion 14 to close the injection hole 230. However, if the size of the ball or pin does not match the injection hole due to tolerances, or if a defect occurs, it may be difficult to completely prevent leakage of the electrolyte. In addition, considering the size and quantity of the sealing members, it may also be difficult to detect such defects in advance.

For this reason, the battery cell manufacturing apparatus 1000 according to the present disclosure may improve the sealing force between the injection hole 230 and the sealing member 210 by thermally fusion-bonding the sealing member 210, thereby preventing leakage of the electrolyte.

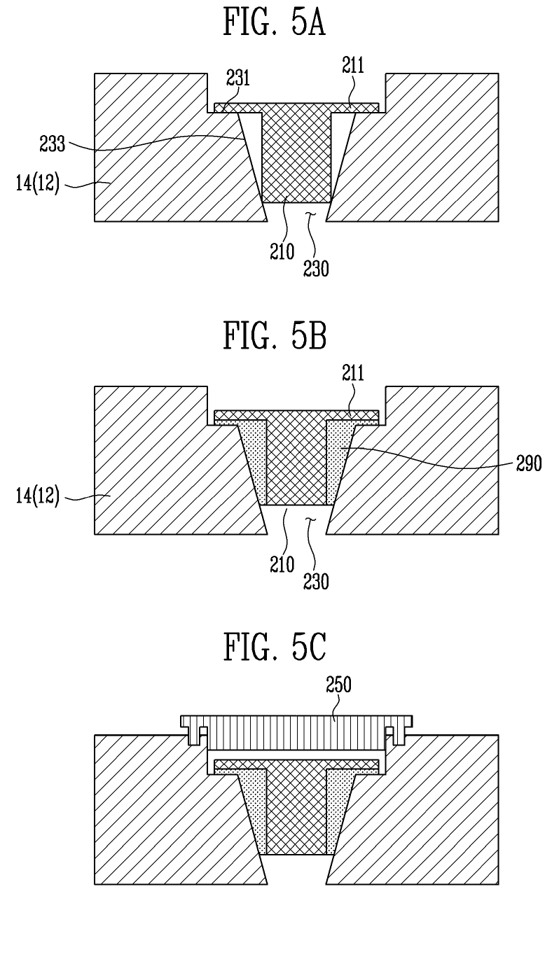

FIGS. 5A to 5C illustrate a method of coupling a sealing member and a sealing cover when the sealing member has a pin shape.

For reference, FIGS. 5A to 5C illustrate the injection hole 230, the sealing member 210, and the fusion portion 290 in an exaggerated manner for explanation.

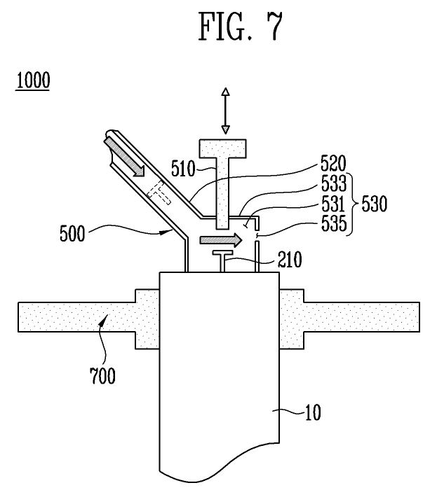

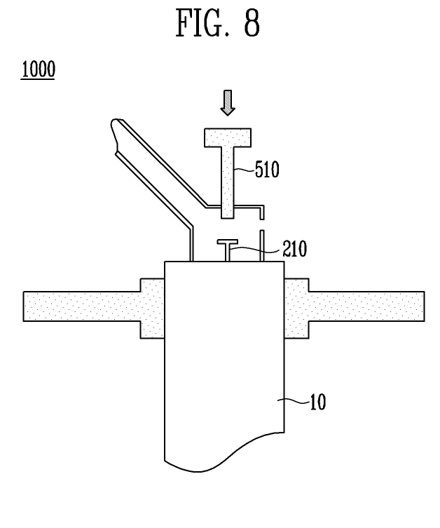

FIG. 5A illustrates an example in which the sealing member 210 is inserted into the injection hole 230 through the battery cell manufacturing apparatus 1000 according to the present disclosure. The insertion of the sealing member 210 may be performed through an insertion unit 500 (see FIG. 7) described in FIGS. 7 and 8.

Referring to FIG. 5A, the pin-shaped sealing member 210 may be inserted such that a head of the sealing member 210 is caught on a stepped portion 231 formed on the inner surface 233 of the injection hole 230. One cross-section of the inner surface 233 of the injection hole 230 may become narrower toward the inside of the case 12. That is, the inner surface 233 of the injection hole 230 may have a tapered shape. This is to ensure that, considering the size and tolerance of the pin-shaped sealing member 210, the sealing member 210 can still be caught on the injection hole 230 even if the size of the sealing member 210 varies. Thereafter, the sealing member 210 may be press-fitted by the pressing portion 510 to be described later. In addition, even if the sealing member 210 is deformed due to thermal fusion to be described later, the tapered shape may maintain or increase the sealing force.

This ensures that the sealing member 210 can be press-fitted into the injection hole 230.

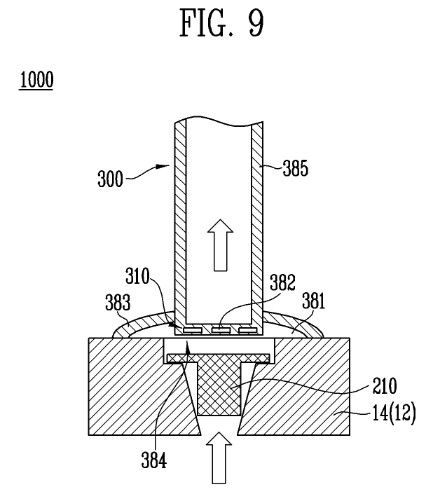

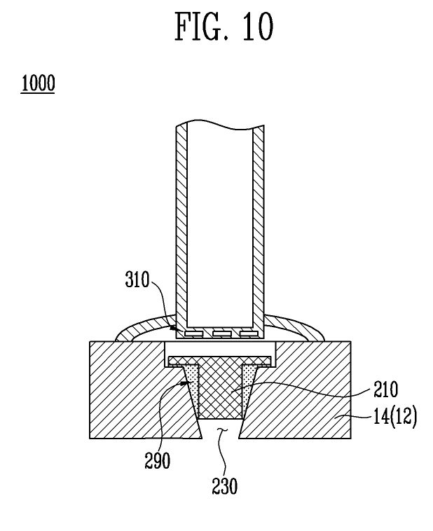

FIG. 5B illustrates an example in which the pin-shaped sealing member 210 is fusion-bonded to the case 12 (or the inner surface 233 of the injection hole 230). The sealing member 210 may be fusion-bonded through the fusion unit 300 (see FIG. 9) described in FIGS. 9 and 10.

Referring to FIG. 5B, the sealing member 210 may be coupled to one surface of the case 12 (the cover portion 14 or the inner surface 233 of the injection hole 230) by a thermal fusion method in which the sealing member 210 is fusion-bonded by heating.

Considering the pin-shaped sealing member 210, the fusion unit 300 may heat the head 211 of the sealing member 210, thereby thermally fusion-bonding the sealing member 210.

When the sealing member 210 is heated, a portion including the head 211 of the sealing member 210 may be deformed, thereby forming a fusion portion 290 between one surface of the case 12 (the cover portion 14 or the inner surface 233 of the injection hole 230) and the sealing member 210.

For the thermal fusion, a melting point of the material of the case 12 may be equal to or higher than a melting point of the sealing member 210. That is, the material of the case 12 may be different from the material of the sealing member 210.

For example, when the material of the case 12 is aluminum, considering that the melting point of aluminum is approximately 660 °C, the melting point of the sealing member 210 may be 300 °C or more and 400 °C or less. This is merely an example, and the melting point of the sealing member 210 is not limited to the above temperature range.

Accordingly, the thermal fusion may be performed by melting or deforming the sealing member 210, while the case 12 is not deformed or melted, to form the fusion portion 290 between one surface of the case 12 (the cover portion 14 or the inner surface 233 of the injection hole 230) and the sealing member 210.

In addition, since the sealing member 210 may be in direct contact with the electrolyte, it may be formed of a material having electrolyte resistance (for example, polypropylene or rubber).

FIG. 5C illustrates an example in which, after completion of the thermal fusion, the sealing cover 250 is coupled to one surface of the case 12 to cover the injection hole 230 and the sealing member 210.

Therefore, referring to FIGS. 5A to 5C, the battery cell 10 manufactured by the battery cell manufacturing apparatus 1000 according to the present disclosure may undergo triple sealing through press-fitting of the sealing member 210, thermal fusion of the sealing member 210, and coupling of the sealing cover 250.

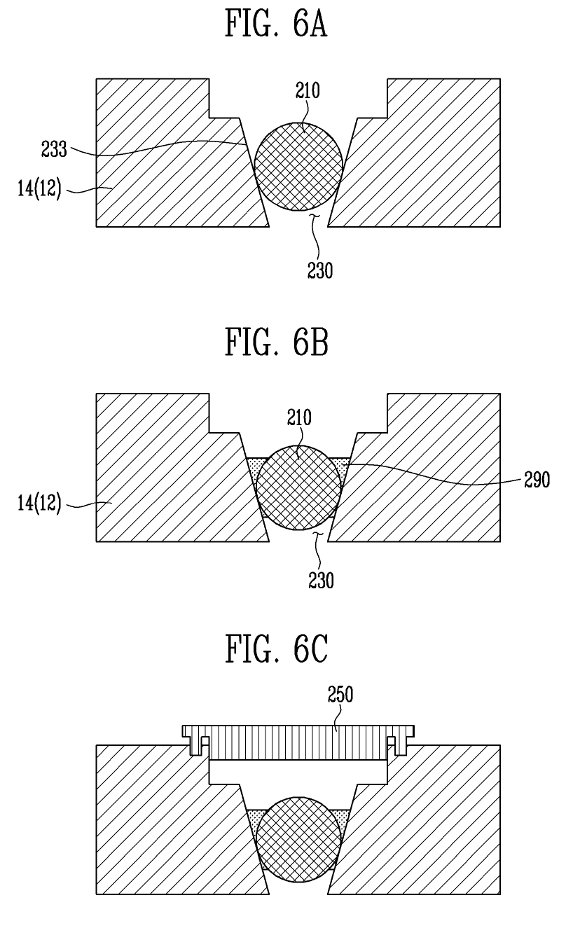

FIGS. 6A to 6C illustrate a method of coupling a sealing member and a sealing cover when the sealing member has a ball shape.

For reference, FIGS. 6A to 6C illustrate the injection hole 230, the sealing member 210, and the fusion portion 290 in an exaggerated manner for explanation.

FIG. 6A illustrates an example in which the sealing member 210 is inserted into the injection hole 230 through the battery cell manufacturing apparatus 1000 according to the present disclosure. The insertion of the sealing member 210 may be performed through an insertion unit 500 (see FIG. 7) described in FIGS. 7 and 8.

Referring to FIG. 6A, the ball-shaped sealing member 210 may be inserted so as to be caught on the inner surface 233 of the injection hole 230. One cross-section of the inner surface 233 of the injection hole 230 may become narrower toward the inside of the case 12. That is, the inner surface 233 of the injection hole 230 may have a tapered shape. This is to ensure that, considering the size and tolerance of the ball-shaped sealing member 210, the sealing member 210 can still be caught on the injection hole 230 even if the size of the sealing member 210 varies. Thereafter, the sealing member 210 may be press-fitted by the pressing portion 510 to be described later.

FIG. 6B illustrates an example in which the ball-shaped sealing member 210 is fusion-bonded to the case 12 (or the inner surface 233 of the injection hole 230). The sealing member 210 may be fusion-bonded through the fusion unit 300 (see FIG. 9) described in FIGS. 9 and 10.

Referring to FIG. 6B, the sealing member 210 may be coupled to one surface of the case 12 (the cover portion 14 or the inner surface 233 of the injection hole 230) by a thermal fusion method in which the sealing member 210 is fusion-bonded by heating.

When the sealing member 210 is heated, a portion of the sealing member 210 may be deformed, thereby forming a fusion portion 290 between one surface of the case 12 (the cover portion 14 or the inner surface 233 of the injection hole 230) and the sealing member 210.

For the thermal fusion, a melting point of the material of the case 12 may be equal to or higher than a melting point of the sealing member 210. That is, the material of the case 12 may be different from the material of the sealing member 210.

For example, when the material of the case 12 is aluminum, considering that the melting point of aluminum is approximately 660 °C, the melting point of the sealing member 210 may be 300 °C or more and 400 °C or less. This is merely an example, and the melting point of the sealing member 210 is not limited to the above temperature range.

Accordingly, the thermal fusion may be performed by forming a fusion portion 290 between one surface of the case 12 (the cover portion 14 or the inner surface 233 of the injection hole 230) and the sealing member 210, while the case 12 is not deformed or melted and the sealing member 210 is melted or deformed.

In addition, since the sealing member 210 may be in direct contact with the electrolyte, it may be formed of a material having electrolyte resistance (for example, polypropylene or rubber).

FIG. 6C illustrates an example in which, after the thermal fusion is completed, the sealing cover 250 is coupled to one surface of the case 12 to cover the injection hole 230 and the sealing member 210.

Therefore, referring to FIGS. 6A to 6C, the battery cell 10 manufactured by the battery cell manufacturing apparatus 1000 according to the present disclosure may undergo triple sealing through press-fitting of the sealing member 210, thermal fusion of the sealing member 210, and coupling of the sealing cover 250.

FIG. 7 illustrates a method of placing the sealing member into the injection hole through an insertion unit.

The battery cell manufacturing apparatus 1000 according to the present disclosure may first insert the sealing member 210 into the injection hole 230 in order to thermally fusion-bond the sealing member 210. For this purpose, the battery cell manufacturing apparatus 1000 according to the present disclosure may further include an insertion unit 500 configured to insert the sealing member 210 into the injection hole 230.

In addition, the battery cell manufacturing apparatus 1000 according to the present disclosure may further include a fixing jig 700 configured to fix a position of the battery cell 10. The fixing jig 700 serves to prevent the position of the battery cell 10 from being changed due to vibration of the battery cell manufacturing apparatus 1000 by fixing the position of the battery cell 10.

The insertion unit 500 may include a supply portion 520 configured to supply the sealing member 210, a guide portion 530 configured to guide the sealing member 210 supplied through the supply portion 520 to the injection hole 230, and a pressing portion 510 configured to press the sealing member 210 guided to the injection hole 230 by the guide portion 530 to insert the sealing member 210 into the injection hole 230.

The guide portion 530 may contact one surface of the case 12 where the injection hole 230 is located. In addition, the guide portion 530 may include a guide housing 533 forming a guide space 531 therein. The sealing member 210 supplied into the guide space 531 may be seated in the injection hole 230.

The supply portion 520 may be provided in a pipe shape and connected to the guide portion 530. The sealing member 210 may be supplied into the guide space 531 through the supply portion 520.

The supply portion 520 may be provided in a pipe shape and configured to move the sealing member 210 according to the flow of air. Therefore, in order to discharge the air back to the outside, the guide portion 530 may further include a guide through-hole 535 penetrating the guide housing 533. An arrow illustrated in FIG. 7 shows an example of the flow of air moving through the supply portion.

Meanwhile, the insertion unit 500 illustrated in FIG. 7 is merely an example, and the method of inserting the sealing member 210 is not limited thereto.

FIG. 8 illustrates a method of inserting the sealing member into the injection hole through a pressing portion.

As described above, the insertion unit 500 may further include a pressing portion 510 configured to move through the guide housing 533 along a direction approaching or moving away from the injection hole 230.

The sealing member 210 seated in the injection hole 230 by the guide portion 530 may be inserted into the injection hole 230 in a press-fit manner by the pressing portion 510.

For this purpose, the pressing portion 510 may contact the sealing member 210 and press the sealing member 210 with a predetermined pressure.

FIG. 9 illustrates an example of surrounding the sealing member through a fusion unit.

The sealing member 210 inserted by the insertion unit 500 may be thermally fusion-bonded between one surface of the case 12 (the cover portion 14 or the inner surface 233 of the injection hole 230) and the sealing member 210 through the fusion unit 300.

The thermal fusion may also be performed by ultrasound, a heater, an ultraviolet (UV) curing agent, or a laser. In the present specification, a method of pressing and heating using a heater is described as an example.

Referring to FIG. 9, the battery cell manufacturing apparatus 1000 according to the present disclosure may include a fusion unit 300 including a heater portion 310 configured to contact the sealing member 210 inserted into the injection hole 230 and heat the sealing member 210.

In addition, the fusion unit 300 may further include a fusion housing 383 including a receiving opening 384 opened at one surface and configured to surround the sealing member 210 through the receiving opening 384, and a fusion pipe 385 having a pipe shape, inserted through the fusion housing 383 and configured to move the heater portion 310 positioned at a lower side into contact with the sealing member 210.

The fusion housing 383 may contact one surface of the case 12 to form a fusion space 381 therein. The fusion space 381 may communicate with the recessed space 231a through the receiving opening 384.

Since the fusion space 381 and the recessed space 231a communicate with each other, the fusion pipe 385 may be inserted into the fusion space 381 through the fusion housing 383 and may move along a direction toward the sealing member 210. The fusion pipe 385 may contact the sealing member 210 and press the sealing member 210.

Since the heater portion 310 is located at a lower end of the fusion pipe 385, the contact of the fusion pipe 385 means contact between the sealing member 210 and the heater portion 310, and the pressing through the fusion pipe 385 may mean pressing of the sealing member 210 by the fusion pipe 385 and the heater portion 310.

Meanwhile, the fusion unit 300 may further include a decompression portion 390 (see FIG. 4) configured to discharge gas from the inside of the case 12 through the fusion pipe 385 at a pressure lower than an internal pressure of the case 12.

The decompression portion 390 may induce discharge of gas (or air) inside the case 12 to the outside by forming a negative pressure.

The fusion pipe 385 may be provided with a decompression hole 382 at a lower side so that, even while the heater portion 310 contacts the sealing member 210 to perform thermal fusion, gas (or air) generated inside the case 12 may continuously be discharged through the decompression hole 382.

An arrow illustrated in FIG. 9 shows an example of gas flow induced by the decompression portion 390.

FIG. 10 illustrates an example of coupling the sealing member to the case by heating the sealing member through a heater portion.

As described above, the fusion unit 300 may include a fusion pipe 385 configured to press the sealing member 210, and a heater portion 310 located at a lower end of the fusion pipe 385 to heat the sealing member 210.

The heater portion 310 may be a heater in a film shape. That is, the heater portion 310 may be coupled to the lower end of the fusion pipe 385 and may move together with the fusion pipe 385 when the fusion pipe 385 moves.

Considering that the fusion pipe 385 has a cylindrical shape, the heater portion 310 may be formed of a flexible material and may be deformed in shape according to the shape of the fusion pipe 385.

The fusion pipe 385 may move along a direction approaching or moving away from the sealing member 210 through the fusion housing 383.

The heater portion 310 may heat the sealing member 210 for a predetermined elapsed time such that at least a portion of the sealing member 210 is deformed to form a fusion portion 290 between the sealing member 210 and the case 12.

FIG. 10 illustrates an example in which the heater portion 310 contacts the sealing member 210, but the heater portion 310 may also be spaced apart from the sealing member 210 and heat the sealing member 210.

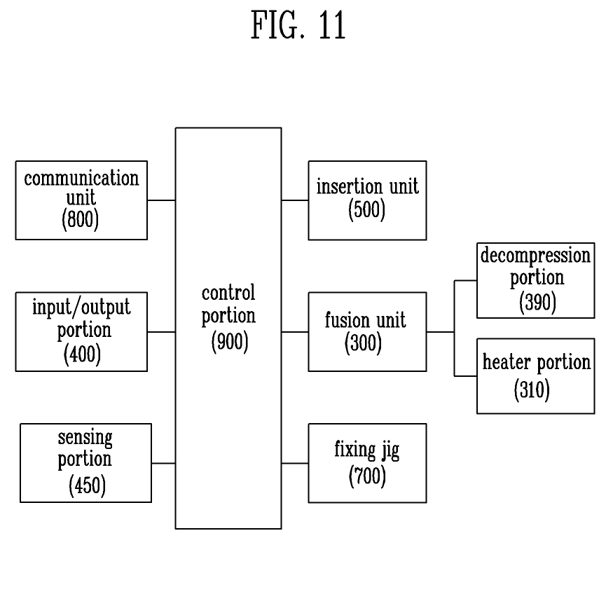

FIG. 11 illustrates a control block diagram of the battery cell manufacturing apparatus according to the present disclosure.

The battery cell manufacturing apparatus 1000 according to the present disclosure may include a control portion 900 configured to control the insertion unit 500, the fixing jig 700, and the fusion unit 300.

Specifically, the control portion 900 may control movement of the insertion unit 500 and the fusion unit 300. In addition, the control portion 900 may control the supply portion 520 and the pressing portion 510 in the insertion unit 500, and may control the decompression portion 390 and the heater portion 310 in the fusion unit 300.

In addition, the battery cell manufacturing apparatus 1000 according to the present disclosure may further include a communication unit 800 configured to receive a command from a user or transmit a notification to a user, and an input/output portion 400 configured to receive a command from the user or output a result. The control portion 900 may control the communication unit 800 and the input/output portion 400.

In addition, the battery cell manufacturing apparatus 1000 according to the present disclosure may further include a sensing portion 450 configured to measure an insertion depth of the sealing member 210 inserted by the pressing portion 510, and the control portion 900 may determine whether the sealing member 210 has been sufficiently inserted through the sensing portion 450.

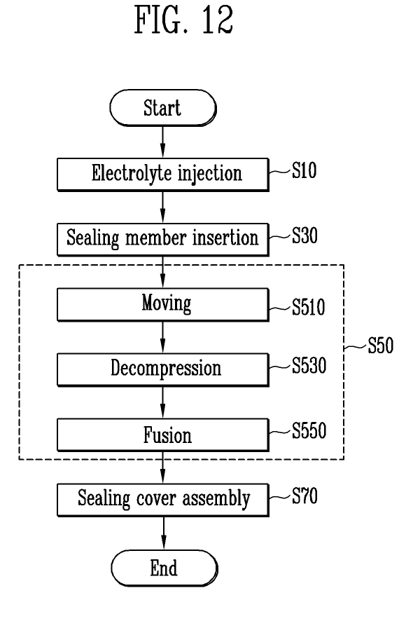

FIG. 12 illustrates an example of a control method of the battery cell manufacturing apparatus according to the present disclosure in a flow chart.

Referring to FIG. 12, a control method of the battery cell manufacturing apparatus 1000 according to the present disclosure may include: a step S30 of inserting the sealing member 210 into the injection hole 230 through the insertion unit 500; and a step S50 of fusion-bonding the sealing member 210 inserted into the injection hole 230 to the case 12 through the fusion unit 300.

In the step S30 of inserting the sealing member 210, the control method of the battery cell manufacturing apparatus 1000 according to the present disclosure may insert the sealing member 210 into the injection hole 230 through the pressing portion 510. The insertion of the sealing member 210 may be performed in a press-fit manner.

In other words, the step S50 of fusion-bonding the sealing member 210 to the case 12 may include, in the fusion unit 300 further comprising a fusion housing 383 including a receiving opening 384 opened at one surface, and a fusion pipe 385 having a pipe shape, inserted through the fusion housing 383 and movable such that the heater portion 310 positioned at a lower side contacts the sealing member 210, a fusion step S550 of heating the sealing member 210 through the heater portion 310 in contact with the sealing member 210 to fusion-bond the sealing member 210 to the case 12.

Meanwhile, the step S50 of fusion-bonding the sealing member 210 to the case 12 may include a fusion step S550 of heating the sealing member 210 through the heater portion 310 in contact with the sealing member 210 to fusion-bond the sealing member 210 to the case 12.

That is, the step S50 of fusion-bonding the sealing member 210 to the case 12 may include, in the fusion unit 300 further comprising a fusion housing 383 including a receiving opening 384 opened at one surface, and a fusion pipe 385 having a pipe shape, inserted through the fusion housing 383 and movable such that the heater portion 310 positioned at a lower side contacts the sealing member 210, a fusion step S550 of heating the sealing member 210 through the heater portion 310 in contact with the sealing member 210 to fusion-bond the sealing member 210 to the case 12.

In addition, the step S50 of fusion-bonding the sealing member 210 to the case 12 may further include, prior to the fusion step S550, a moving step S510 of bringing the fusion housing 383 into contact with the one surface of the case 12 while the fusion housing 383 surrounds the sealing member 210 through the receiving opening 384, and a decompression step S530 of moving the fusion pipe 385 to contact the sealing member 210 and discharging air inside the case 12 through the fusion pipe 385.

When the fusion housing 383 contacts one surface of the case 12 and surrounds the injection hole 230 and the sealing member 210, decompression may be started even if the fusion pipe 385 does not contact the sealing member 210. Therefore, in the control method of the battery cell manufacturing apparatus 1000 according to the present disclosure, decompression may be initiated before the fusion pipe 385 comes into contact with the sealing member 210.

In addition, the control method of the battery cell manufacturing apparatus 1000 according to the present disclosure may further include, after the step S50 of fusion-bonding the sealing member 210 to the case 12, a step S70 of assembling the sealing cover 250 to the case 12 such that the sealing cover 250 surrounds the sealing member 210 fusion-bonded to the case 12.

In addition, the control method of the battery cell manufacturing apparatus 1000 according to the present disclosure may perform, prior to the step S30 of inserting the sealing member 210, a step S10 of injecting the electrolyte into the inside of the case 12 through the injection hole 230.

Meanwhile, the step S10 of injecting the electrolyte and the step S70 of assembling the sealing cover 250 to the case 12 may also be performed by separate battery cell manufacturing apparatuses 1000. For this purpose, the battery cell 10 under manufacture may be moved toward each apparatus.

The present disclosure may be embodied in various forms, and the scope of rights is not limited to the above-described embodiments. Therefore, if a modified embodiment includes the constituent elements of the claims of the present disclosure, it shall be regarded as belonging to the scope of the present disclosure.

What is claimed is:

1. A battery cell manufacturing apparatus for manufacturing a battery cell comprising a case accommodating an electrode assembly, an injection hole penetrating one surface of the case, and a sealing member coupled to the case to cover the injection hole, the battery cell manufacturing apparatus comprising:
a fusion unit including a heater portion configured to contact the sealing member inserted into the injection hole and heat the sealing member.

2. The battery cell manufacturing apparatus according to claim 1, wherein the heater portion is a heater in a film shape.

3. The battery cell manufacturing apparatus according to claim 1, wherein the fusion unit further comprises:
a fusion housing including a receiving opening opened at one surface and configured to surround the sealing member through the receiving opening; and
a fusion pipe having a pipe shape, inserted through the fusion housing, and configured to move the heater portion positioned at a lower side into contact with the sealing member.

4. The battery cell manufacturing apparatus according to claim 3, wherein the fusion unit further comprises a decompression portion configured to discharge gas from the inside of the case through the fusion pipe at a pressure lower than an internal pressure of the case.

5. The battery cell manufacturing apparatus according to claim 1, wherein the heater portion heats the sealing member for a predetermined elapsed time such that at least a portion of the sealing member is deformed to form a fusion portion between the sealing member and the case.

6. The battery cell manufacturing apparatus according to claim 1, further comprising a fixing jig configured to fix a position of the battery cell.

7. The battery cell manufacturing apparatus according to claim 1, further comprising an insertion unit configured to insert the sealing member into the injection hole.

8. The battery cell manufacturing apparatus according to claim 7, wherein the insertion unit comprises:
a supply portion configured to supply the sealing member;
a guide portion configured to guide the sealing member supplied through the supply portion to the injection hole; and
a pressing portion configured to press the sealing member guided to the injection hole by the guide portion to insert the sealing member into the injection hole.

9. The battery cell manufacturing apparatus according to claim 8, wherein the pressing portion inserts the sealing member into the injection hole in a press-fit manner.

10. A control method of a battery cell manufacturing apparatus including an insertion unit and a fusion unit, the insertion unit being configured to insert a sealing member, and the fusion unit including a heater portion configured to contact and heat the sealing member, for manufacturing a battery cell comprising a case accommodating an electrode assembly, an injection hole penetrating one surface of the case, and the sealing member coupled to the case to cover the injection hole, the control method comprising:
inserting the sealing member into the injection hole through the insertion unit; and
fusion-bonding the sealing member inserted into the injection hole to couple the sealing member to the case through the fusion unit.

11. The control method of the battery cell manufacturing apparatus according to claim 10, wherein the inserting of the sealing member comprises inserting the sealing member into the injection hole through a pressing portion of the insertion unit, the insertion unit including a supply portion configured to supply the sealing member, a guide portion configured to guide the supplied sealing member to the injection hole, and the pressing portion configured to press the sealing member guided to the injection hole by the guide portion.

12. The control method of the battery cell manufacturing apparatus according to claim 11, wherein the inserting of the sealing member comprises inserting the sealing member in a press-fit manner through the pressing portion.

13. The control method of the battery cell manufacturing apparatus according to claim 10, wherein the coupling of the sealing member to the case by fusion comprises a fusion step of heating the sealing member through the heater portion in contact with the sealing member, in the fusion unit further comprising a fusion housing including a receiving opening opened at one surface, and a fusion pipe having a pipe shape, inserted through the fusion housing, and movable such that the heater portion positioned at a lower side contacts the sealing member, thereby fusion-bonding the sealing member to the case.

14. The control method of the battery cell manufacturing apparatus according to claim 13, wherein the coupling of the sealing member to the case by fusion further comprises:
a moving step of bringing the fusion housing into contact with the one surface of the case while the fusion housing surrounds the sealing member through the receiving opening, prior to the fusion step; and
a decompression step of moving the fusion pipe to contact the sealing member and discharging air inside the case through the fusion pipe.

15. The control method of the battery cell manufacturing apparatus according to claim 11, further comprising, after the coupling of the sealing member to the case by fusion, assembling a sealing cover to the case such that the sealing cover surrounds the sealing member fusion-bonded to the case.
